(19) United States
(12) Patent Application Publication
(10) Pub. No.: US 2017/0132395 A1
(43) Pub. Date: May 11, 2017

(54) Connected Digital Health and Wellbeing Platform and System

(71) Applicant: Tom FUTCH, Mooresville, NC (US)

(72) Inventor: Tom FUTCH, Mooresville, NC (US)

(21) Appl. No.: 15/247,171

(22) Filed: Aug. 25, 2016

Related U.S. Application Data
(60) Provisional application No. 62/209,443, filed on Aug. 25, 2015.

(51) Int. Cl. G06F 19/00

(52) U.S. Cl. CPC G06F 19/3481; G06F 19/328

(57) ABSTRACT

A connected digital therapeutics navigation guidance system for lifestyle modification and disease prevention is provided. The system includes one or more wearable user devices to detect user data relating to one or more health or fitness parameters, receive user input data relating to the one or more health or fitness parameters through the user interface and a request for a health or fitness routine from a server, which provides the wearable user device with a routine that can be performed by the user of the wearable user device.

### CROSS-REFERENCE TO RELATED APPLICATIONS

The present application claims the benefit of U.S. Provisional Patent Application No. 62/209,443, filed Aug. 25, 2015, which is hereby incorporated by reference in its entirety.

### BACKGROUND OF THE INVENTION

Americans are profoundly unhealthy and the cost of disease, not the cost of medicines, threatens the US healthcare system and economy. One in four adults is obese, one in five smoke and most adults live largely sedentary and unhealthy lifestyles. Estimates of the cost of obesity to the American healthcare system are $152 billion per year—and that figure is certain to rise as obesity rates skyrocket across America. Millions of Americans are not getting the message that their lifestyle and behavior are killing them. Most disease and obesity are preventable. Preventable illness makes up approximately 80% of the burden of illness and 90% of all healthcare costs. Obesity is a leading cost factor both physically and financially. In 2011, the CDC estimated that healthcare costs exceeded $8600 annually (per capita). Another study estimated that medical spending attributable to obesity was estimated to be more than $1400 higher than normal weight individuals. In addition to weight, another major factor in the health decline is sedentary lifestyles. Sedentary jobs have increased 83% since 1950; physically active jobs now make up less than 20% of the workforce. In 1960, about half of US workers were physically active. In addition, the US workweek is longer. Full-time workers in the US work about 47 hours each week, which leads to 350 extra hours worked each year. In addition to the individual increased costs, for many companies health costs use up 50 percent or more of their corporate profits. The indirect costs of poor health, such as an absence from work and reduced work productivity, can result in two to three times the amount of direct medical costs. With all of these issues, consumers, employers and government are struggling with which options are best and how best to use emerging resources to get healthier. The most popular of late are wearable technologies and companies delivering activity trackers and software that can monitor an individual's daily activity patterns, exercise intensity, sleep efficiency and even nutrition consumption.

One of the biggest problems facing this exploding wearable technology market is that consumers use these devices for short periods of time and quickly abandon them. The static data they receive from the device is meaningless without a context and system that interprets and moves them forward in healthy habit formation. Like other wellness, health or weight loss programs on the market, consumers face huge problems with maintaining engagement for sustained periods of time.

### SUMMARY OF THE INVENTION

The present invention relates to a connected digital therapeutics navigation guidance system for lifestyle modification and disease prevention. The present invention will help guide the user through sustained healthy habit formation and behavior change key areas of health and wellbeing improvement. The present invention bridges the existing gap between static data and healthy habit formation. Sectors in need of this tool include employer wellness, health insurance payers, healthcare and consumers. A brief overview of how the solution will help each of these sectors solve their current needs follows.

To combat the continual trend towards unhealthy lifestyles and chronic disease, employers are adopting health promotion and disease prevention strategies that take advantage of their access to employees at an age when interventions directed at healthy behaviors can still change long-term health trajectory. These strategies range from changes to the working environment, such as providing healthy food options in the cafeteria, to comprehensive interventions that support employees in adopting and sustaining healthy lifestyles. One of the most popular trends is providing employees with wearable activity tracking devices and running wellness challenges across their entire population of employees, spouses and/or significant others. Although employers project continued investment in providing wellness programs and incentives for their employees, they have expressed frustration with the ability to get their employees (and others covered by benefits) to be accountable for their health improvement and stick to a program that will improve their health long term. This lack of engagement and motivation is a major problem facing corporate America as they not only bear the costs of medical bills but also they face significant cost increases in absenteeism and a lack of productivity by unhealthy employees. Executive administrators of the wellness programs want offerings that can help individuals change their behavior and develop healthy habits. They are willing to subsidize or pay for these offerings if they show that they can be effective in getting their employees active and healthier. In addition, health coaches, such as, healthcare providers, fitness trainers and nutritionists want the same thing. They also want to be able to run data analytics on their population to explain and defend budgets and prove how well these programs are doing on an annual basis. The programs available today do not address either of these concerns. For example, many corporations are purchasing wearable activity trackers for their entire employee base while rolling out annual wellness challenges. They establish an arbitrary goal, such as, taking 10,000 steps, assigning everyone in the company to a team to earn points and incentives for getting to this goal. This program typically starts out with excitement as the employees get their new devices but quickly wanes as the novelty of wearing that device wears off. These programs do not provide long-term benefits, ultimately frustrating the participants and company wellness officers. Most importantly, the individual does not learn how to sustain the new health behaviors that would signify true change such as moving more daily. Employers are struggling to determine which programs add the most value and return on their investment without true tracking or engagement measures offered through these existing platforms.

The present invention helps administrators roll out an effective program that is focused not just on static data points, but instead on healthy habit formation built on a technology platform that tracks the progress the user makes toward true health behavior change. The platform experience motivates users to keep them engaged to achieve their health improvement goals.

The fitness industry (health and fitness clubs, personal fitness trainers and health coaches) has also seen a recent trend towards members using technology to assist them in the goals of getting healthier and fit. In a recent survey conducted in partnership with The American Council on Exercise, it was uncovered that personal trainers largely believe that wearable devices can create more efficient and effective interaction with health and fitness professionals. The devices provide a means for clients to track physical activity and nutrition habits when away from the gym, giving the health professionals a means of accessing important data previously only available via self-reporting, which is a potentially biased and unreliable process. Consumers have embraced wearable activity devices, so health professionals must determine how to integrate the technology into training programs, memberships and everyday client interaction. In this survey it was found that:
72 percent of respondents report that clients or class participants are asking for insight and feedback on wearable devices, but only 51 percent feel they are prepared to answer those questions.
86 percent of respondents said that a single platform that gathered their clients' data from wearable devices and apps onto a single platform would be of value in the programming and training of clients and in their businesses.
75 percent of respondents would be interested in the capability to run fitness challenges with clients using the wearable activity devices.
71 percent of respondents currently own a wearable activity device, and 61 percent of those who do not yet own one are considering purchasing one.
When asked about what gaps exist with the wearable activity devices, the most common responses were the inability to track all of my physical activity (strength training, recreational activities, etc.), accuracy and better consumer education on the use of devices (i.e., how to set up, how to use, etc.).

These results show that the majority of fitness professionals are hearing questions from clients about wearable activity devices, but may not be able to answer those questions. Fitness experts need a platform that helps them engage their members in a sustained manner and need data to prove that the programs are working.

Consumers are adopting wearable technology and health applications at a very fast rate, but largely not using them or learning the new behaviors that allow them to sustain long-term benefits. These devices and applications have tremendous potential but the data that consumers obtain is noisy and does not show where to focus in order to achieve goals.

Delivering a consumer wellness platform in accordance with the present invention, based on personalized healthy habit formation will unlock the potential for individuals, groups and large populations of society to more effectively activate and engage on health and improvement goals and most importantly, sustain those behaviors long-term.

Habit formation is a step-by step personalized process. The present invention will guide individuals through this process by first understanding where they are at in relation to a specific, personalized health goal, then helping them to establish a realistic path toward that goal, rather than the pursuit of an arbitrary goal set externally for them. The “Habit Tree” helps users by smartly laddering-up their frequency, intensity, and consistency over time. A user will initially be provided a daily target in relation to their daily average as recorded by their wearable device. The user is asked to pursue that daily target for one day. When that target intensity is achieved for one day, they are asked to sustain that intensity at a frequency measured in number of days per week. When the target frequency is achieved, the user is challenged to consistently sustain that frequency goal for the next three consecutive weeks. The habit-building process becomes natural and an essential key to their success.

The solution of the present invention focuses on the most important health and wellness pillars as it relates to preventative wellness. These are: activity, exercise, sleep, nutrition/weight loss and stress. The present invention will help in many chronic conditions as well, such as, cardiovascular disease, diabetes and other health conditions, and has the ability to address critical healthcare cost issues like medication adherence.

An example follows: Tom wants to get more active on a daily basis. Tom sets up his user account within the application of the system of the present invention, and wears his activity tracker for an assessment period, called the “360 Lifestyle & Metabolic Assessment.” During this seven-day period, it is determined that Tom, on average, takes 4,000 steps per day. Following the assessment period, the system will recommend a realistic goal for his starting point as 5,000 steps per day (a 25% increase over his daily average). Tom will then receive reminders daily as to how he is doing. Once Tom achieves the 5,000 step amount in one day, he will receive recognition for his achievement and then will ladder up to the next goal which would be to achieve 5,000 steps for 5 out of 7 days in a week. Again, once he achieves this goal, then he would ladder up to have a new goal of sustaining this frequency (5,000 steps for 5 out of 7 days) for 3 consecutive weeks. After 6 weeks, Tom would have received points for his achievement, but most importantly he develops a sustainable way to increase his daily activity through healthy habit formation. He learns the process of creating healthy habits such that his long term health improvement is much more likely and learns the association of these new healthy habits to the actual achievement of the health improvement goals. Tom is empowered and feels motivated to try additional health improvement steps.

Prior solutions have focused on the end-goal instead of the interim small steps necessary to sustain health improvement. One of the most common corporate wellness programs is the 10,000 step program. By arbitrarily asking everyone to achieve 10,000 steps per day they are setting many up to fail. Another area where past programs have failed is in the attempt to apply arbitrary incentives to both challenges and wellness programs. Applying incentives in a broad and arbitrary manner can have a detrimental effect long term on the individual's ability to achieve success. The carrot or the stick approach has been long debated.

The present invention takes a different approach versus traditional methods by crossing emerging behavioral change models with adaptive technologies to create compelling and sustainable consumer experiences. The incentives can not only be tied to the beginning of a program (activation) but also to the ongoing engagement and longer term overall positive health outcomes. The wellness platform of the present invention facilitates learning to develop healthy habits utilizing digital health and wearable technology combined with a unique motivational methodology for behavior change.

The system according to the present invention will create a path to wellness for consumers by emphasizing incremental simple changes and healthy habit formation; personalize content to make it meaningful and unique to their needs and goals (instead of a user having to look in many places like magazines, online, or TV, they have it at their fingertips); keep users engaged over the long term; make it easy to get started and participate as an individual, group or team so they can leverage the benefits of social health and well-being; provide the ability for users to learn about their current state of health to have a starting point based on personal patterns; recognize participation and celebrate consistency; help each user learn their personal “triggers” for healthy habit formation; and provide the ability to change behaviors for key health and wellness areas: physical activity, exercise, sleep, nutrition and stress.

The user looks to the health and wellness platform and system of the present invention to be their guidance system to achieving healthier behaviors on a daily basis. The system provides a “scoring system” that will act as this guidance each day for individuals, for groups and for teams. Instead of having to look at multiple numbers daily, the user is able to look at one number to see how they are tracking daily. This score reinforces the need to hit the healthy habits in a consistent fashion as this is the only way to score at the highest levels.

The system and platform of the present invention includes a lifestyle assessment and insight analysis, which provides the user with detailed lifestyle and behavior insights on the objective reality of the individual's daily patterns (e.g., physical activity, exercise, sleep, nutrition) prior to using the system. This objective starting point provides a reality baseline for the user to set reasonable goals for improvement and insights backed by objective data on their daily patterns. This analysis is provided from a seven-day period of using the system. Each insight report may provide, for example detailed red, yellow and green waypoint flags and insight comments to call out areas where the user is achieving above or below recommended goals for a particular health pillar. For example, as the physical activity and exercise intensity areas is examined, a detailed graph of daily activity and exercise intensity hour by hour is provided with associated flags for when the user had the greatest level of intensity. In addition, timeframes when the levels were at their lowest can be noted. Below the graphs, information is provided to the user on proper levels for individuals to achieve on a daily basis. This assessment and insights report can be provided also at any time during the individual's use of the system ongoing. This will allow the user to assess their last 7 day trend and get insights on that data.

This system and platform of the present invention also helps the user learn how to replace poor health habits with positive ones in a repeatable process hour by hour and day by day. This ramp-up process helps the user to understand that in order to achieve long-term success they must first achieve step by step success. Once they are successful at achieving the goals in a day's period of time then they are motivated and nudged to do the same in a week's period of time. This step by step process is a more effective approach to long-term goal achievement versus setting an arbitrary goal that the user has little chance of achieving.

A habit scheduler in accordance with the invention provides a unique method for scheduling (planning) a user's health and fitness habits and routines just as they do their daily and weekly calendar. By properly pre-planning a daily schedule for positive health tasks/actions/habits, the user will learn the proper mindful living behaviors that lead to long term success. In addition, the user will learn the critical factor of the correlation with health habits achievement and the overall goal attainment for the day. This critical association will serve as a foundation for short and longer term healthy habit formation. An example of a healthy habit may be to drink more water, and the actions/task associated could be, for example, to set alarms or bring a water bottle to work every day. The habit itself would be to achieve drinking more water. By pre-planning and scheduling these actions/habits the individual will be more mindful about their day and have greater success in achieving their goal.

Each day the individual will receive prompts or alarms via their mobile device to alert them to their upcoming scheduled healthy habit. This alarm will be provided to the user in advance of the actual time for the habit with the intent to keep them accountable to achieving the habit.

In addition to the functionality of the habit scheduler in its ability to aid the user to pre-planning their habits, a unique user interface with visual cues is incorporated to provide context to the user as to how far they have come in their goal achievement for the day/week/month. The interface provides simple feedback in terms of where the user is at in terms of their goal.

A habit library provides a reference source that is first validated by experts in the field of physical activity, exercise, nutrition, sleep and stress and then second further supported by data intelligence for users of the system as to which habits are best for a particular user. Consumer attitude and behavior segmentation is utilized to group users into such that data is simply compiled real-time. The larger the database of users is the more information will be compiled on user's habits and behaviors. This database library may be reviewed and assessed on a regular basis by expert health coaches for data analysis to review trends and key points of interest. This database will grow in terms of users, habits, interactions and overall progress.

An artificial intelligence and personalized data analytics feedback provides the user with predictive feedback on recommended tips, habits and insights that the system has gained from analyzing the data points of users and from expert coach analysis.

Population data analytics provides program administrators with detailed user data analytics on real-time population user activation, engagement and goal achievement success. The unique approach to incentivizing and measuring not only goal achievement but also habit formation will allow administrators to have a real-time view on how engaged or not the population is with a particular wellness program initiative. For health coaches, the system will provide a simplified method for rewards and points that helps guide the user through health improvement and provides a fun and inspiring gamification method for participation and progress.

An engagement driven rewards incentive program provides the administrator with a unique ability to tie incentives to an actual engagement and overall progress in the program versus just with the activation of the program. This is a major improvement for incentive benefit plan design as in the past, the incentives have been paid out for just activating (starting) in the program. The problem with only incentivizing the start is that most of the participants drop off shortly after they started and received their incentive. This is a major waste of money for health insurance payers and for employers. Today's healthcare system requires that users be more accountable for their health improvement, therefore, gauging their actual engagement and their progress on healthy habit formation and behavior change needs to be a critical part of that equation. For example, an employer offers an incentive for the employee to sign up for the program. They receive an incentive from the employer for signing up and taking the assessment. Then the system will track the engagement of the employee week-by-week throughout the year. Each week that the employees achieve a set percentage of use with the healthy habit system and goal achievement, they will receive an additional incentive towards their premium reduction for the year. In addition, the employee will receive an additional premium discount based on actual health biometrics improvement year over year. In addition to receiving the additional incentives, the system allows the employer administrator to track engagement for those employees that have fallen off of the program so that they can message them and attempt to get them back on track. In addition, the system methodology allows the user to be focused on the health improvement goal of their choice and not just “steps” like most other population wellness programs on the market today. A lack of sleep as an example has been linked to higher rates of obesity.

The unique user interaction process allows tying habit formation and goal achievement to a daily “HEALTHPILOT Wellness Score” that the user will generate. This Score will provide the user with the ability to participate in wellness challenges individually or on teams whereby they will be recognized for their habit and goal achievement. The score is unique in that it is looking at their progress from their baseline starting point versus an arbitrary goal that is set forth from a program administrator. This approach allows the entire population to participate in their wellness program and challenge on a level playing field. In other words, a very fit person can be on the same team as someone that is less fit and they are all measured based on their progress from their baseline. Comparing a triathlete to someone struggling to improve their health, for example, can be done by comparing their progress from their respective baselines. If a person that is walking 2000 steps learns healthy habits and behaviors and progresses to walking 8000 steps regularly, that is a huge improvement for that individual.

Further in accordance with the invention, each user may receive educational tips from health experts and relevant expert articles, videos and blogs relating to their specific health improvement goals. This targeted approach for communication allows a very focused and intentional learning and understanding that takes place with the user. The interaction by the user with educational content information will also allow the user to receive additional incentive points in the overall wellness program. Employer administrators and health coaches are continually looking for ways to better educate their members on holistic health and well-being and are willing to tie this education progress to their engagement in these practices.

In addition, the tracking for points and progress in the system is done with objective tracking versus subjective tracking. This objective tracking is gained from actual wearable data, actual inputs from the user in the system and actual results tracked daily.

In accordance with the invention, health coaches (e.g., personal fitness trainers, nutritionists, healthcare providers) have the ability to use the system with their members as a foundational system to interact with them on a real-time basis. This “HEALTHPILOT Coach Connected System” will allow the coach to remotely monitor the user's progress, provide interactive coach tips via a coach messaging tool and to allow the user to participate in challenges with the other members the coach is training. This connected system approach to training provides the health coach with the unique ability to provide as much or as little interaction with the user as necessary. A health coach can be a fitness trainer, nutritionist, physician or physical therapist, for example.

Social networking solutions in accordance with the invention will be led by the analytics that are learned from the consumer segmentation and health habits formation. By segmenting the user population tips, content and helpful insights can be shared to the social community in a dynamic manner. In addition, the social community will have the ability to share tips with each other as well on what is working best for them under the framework of the habit formation and behavior change system.

A connected API module in accordance with the invention provides the ability to plug the system into a broader platform for use in their business model and offering. This modular approach will allow other organizations to take advantage of the behavior change system of the invention and apply it to their platform. This will include companies such as, wearables, smart watches, mobile devices, digital health devices, healthcare providers, health insurance payers and healthcare provider electronic records.

In accordance with a first aspect of the invention, a health and fitness improvement system is provided comprising a wearable user device comprising a user interface, a memory and a processor, and a server. The wearable user device is configured to detect user data relating to one or more health or fitness parameters; receive user input data relating to the one or more health or fitness parameters through the user interface; and transmit the detected user data and user input data to the server with a request for a health or fitness routine. The server is configured to receive the detected user data and user input data with the request for a health or fitness routine; determine based on the received detected user data and user input data a health or fitness routine for transmission to the user; and transmit the health or fitness routine to the wearable user device.

In accordance with an embodiment of the first aspect of the invention, the server may comprise a recommender engine configured to store a plurality of health or fitness routines, each associated with a data set relating to the one or more health or fitness parameters, and the recommender engine may be configured to select a routine for transmission to the user by comparing the received detected user data and user input data with the data sets relating to the one or more health or fitness parameters associated with the plurality of stored health or fitness routines. The server may be configured to store a user profile associated with the wearable user device. The system may further comprise a plurality of wearable user devices, and the server configured to store user profiles associated with each of the plurality of wearable user devices. Each of the plurality of wearable user devices may be configured to request and receive a routine from the server, and further configured to: detect user data relating to one or more health or fitness parameters related to the received routine; receive user input data relating to the one or more health or fitness parameters related to the received routine through the user interface; and transmit the detected user data and user input data related to the received routine to the server. The recommender engine of the server may be configured modify the data sets associated with the plurality of stored routines based on the detected user data and user input data related to the received routine from the plurality of wearable user devices.

The system may also include an administrator device configured to access a plurality of the user profiles associated with each of the plurality of wearable user devices. Each of the wearable user devices may be configured to participate in a challenge with one or more of the plurality of wearable user devices, wherein each wearable user device can be configured to detect user data relating to one or more health or fitness parameters relating to the challenge; receive user input data relating to the one or more health or fitness parameters relating to the challenge through the user interface; and transmit the detected user data and user input data relating to the challenge to the server.

In accordance further with the first aspect of the present invention, the detected user data may include data relating to one or more of sleep activity, heart rate, steps taken by the user or measured physical activities of the user, and the user input data may include one or more of user dietary information, user health information, user fitness information and a requested area of user health or fitness improvement.

The wearable user device of the system of the first aspect of the invention may be configured to provide alarm notifications to the user relating to the performance of the routine. The alarm notification can be configured to be triggered when the wearable user device detects that the wearable user device is at a particular geographic location.

In accordance further with the first aspect of the invention, the server may be configured to determine user schedule information based on the detected user data and user input data, and to transmit the user schedule information with the health or fitness routine to the wearable user device. The user schedule information may comprise instructions, which when executed by the processor of the wearable user device, instruct the wearable user device to provide alarm notifications to the user relating to the performance of the routine at one or more particular times.

Further in accordance with the first aspect of the invention, the server may be configured to segment users having similar user data or user input data relating to one or more health or fitness parameters stored in their respective user profile into a group. Additionally, the wearable user device may be configured to transmit the detected user data and user input data to the server for a predetermined period of time, and the server may be configured, at the end of the predetermined period of time, to generate and transmit to the wearable user device a baseline user assessment.

In accordance further with the first aspect of the invention he health or fitness routine transmitted to the wearable user device is designed to incrementally improve an area of the user's health or fitness. The server may comprise a content library comprising content relating to a plurality of health or fitness routines, and be configured to transmit to the wearable device with the health or fitness routine, one or more content items from the content library related to the transmitted health or fitness routine.

### BRIEF DESCRIPTION OF THE FIGURES

FIG. 1 illustrates an overview of the health and wellness platform ecosystem in accordance with the present invention.

FIG. 2 illustrates an overview of the health and wellness platform in accordance with the present invention.

FIG. 3a illustrates an overview of the system in accordance with an embodiment of the present invention.

FIG. 3b illustrates an example of a healthy habit recommendation system in accordance with an embodiment of the present invention.

FIG. 4 illustrates a habit scheduler in accordance with an embodiment of the present invention.

FIG. 5 illustrates an example user profile in a user application in accordance with an embodiment of the present invention.

FIG. 6 illustrates an example of a habit tree in accordance with an embodiment of the present invention.

FIG. 7 illustrates an example of the habit tree and building process in accordance with an embodiment of the present invention.

FIG. 8 illustrates an example of a health habit challenge in accordance with an embodiment of the present invention.

FIG. 9 illustrates a healthy habit challenge display in a user application in accordance with an embodiment of the present invention.

FIGS. 10A-10C illustrates selecting a habit in a user application of the system in accordance with an embodiment of the present invention.

FIG. 11 illustrates reviewing daily device data in a user application of the system in accordance with an embodiment of the present invention.

FIG. 12 illustrates developing and unlocking habits to reach user's goal and completing a habit routine in a user application of the system in accordance with an embodiment of the present invention.

FIG. 13 illustrates an administrator challenge creator in a user application of the system in accordance with an embodiment of the present invention.

FIG. 14 illustrates viewing and accepting a challenge invitation in a user application of the system in accordance with an embodiment of the present invention.

FIG. 15 illustrates checking an active solo challenge in a user application of the system in accordance with an embodiment of the present invention.

FIG. 16 illustrates viewing a weekly report for a challenge in a user application of the system in accordance with an embodiment of the present invention.

FIG. 17 illustrates checking an active team challenge status in a user application of the system in accordance with an embodiment of the present invention.

FIG. 18 illustrates winning a challenge in a user application of the system in accordance with an embodiment of the present invention.

FIG. 19 illustrates learning and healthy living content in a user application of the system in accordance with an embodiment of the present invention.

FIG. 20 illustrates a weekly dashboard in a user application of the system in accordance with an embodiment of the present invention.

FIG. 21 illustrates an administrative dashboard report in a user application of the system in accordance with an embodiment of the present invention.

FIG. 22 illustrates a habit and challenge in accordance with an embodiment of the present invention.

FIG. 23 illustrates several areas of health improvement addressed the system of the present invention.

FIGS. 24a and 24b illustrate examples of cardiac rehabilitation treatment programs in accordance with the prior art and the present invention, respectively.

### DETAILED DESCRIPTION OF THE FIGURES

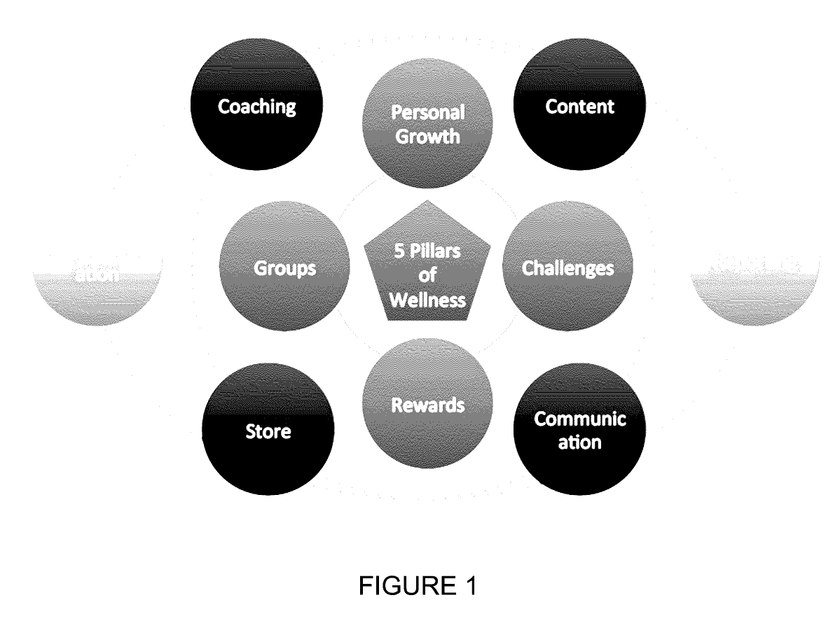

The present invention will now be described with reference made to FIGS. 1-23.

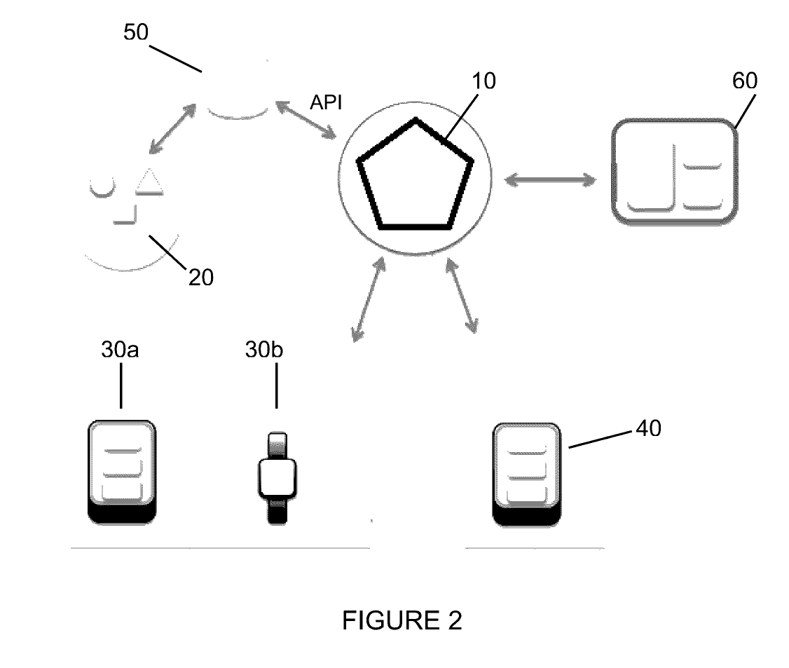

An overview of the health and wellness platform ecosystem of the invention is shown in FIG. 1 and an overview of the system for the health and wellness platform of the invention is shown in FIG. 2.

The system according to the invention comprises one or more user wearable devices 20 and/or mobile devices 30a, 30b, 40. These devices comprise at least a user interface for providing user input, a display, a receiver, a transmitter, a memory configured to store an application according to the invention and a processor configured to execute the application. The wearable devices 20 used in the system of the present invention may be wearable devices known in the art, such as smartwatches, wrist bands, mobile devices and any other device that is configured to collect health and activity information from a user wearing the device. The wearable device 20 can be configured to detect user information relating to many health and fitness parameters, including but not limited to heart rate, steps and elevation of the user, sleeping patterns, electrocardiogram, blood pressure, stress and blood sugar. The wearable device 20 may further include an associated device, such as a mobile device or computer, that is synched with the wearable device 20 to receive user data collected from the wearable device 20 and display the data to the user in a user application. The user may also manually input data relating to various health and fitness parameters using a user interface of the wearable device 20 or associated device, including but not limited to height, weight, age, dietary information, daily schedules, emotional information and physical activity information. The application of the invention is not limited to being run on any particular brand of wireless mobile or wearable device, any apparel-based body monitoring products, or any particular operating system. For example, the devices 30a and 30b may be configured for an iOS operating system, whereas the mobile device 40 is configured for an alternative operating system.

The devices are in wireless communication with a server 50, which comprises a memory configured to store health and wellness related information for a user, and a processor. Such information can be input by a user manually using the user device 20 or can be automatically determined by the device 20 through the user application, as previously described. For example, the device 20 can track a user's steps or sleep information and transmit this information to the server 50 through the application. A programming interface can incorporate this information into accessible portions of the application for the user, such as the user's profile, so that the user can access the information in the context of its objectives in the application.

The system may further comprise a separate mobile or computing device 60 that is accessible by an administrator. The administrator device 60 can comprise at least a user interface for providing user input, a display, a receiver, a transmitter, a memory configured to store an application according to the invention and a processor configured to execute the application. The administrator device 60 may access the data stored relating to one or more users of the application who have granted such access to the administrator. A health professional or trainer, for example, may operate as user of an administrator device 60, so as to be able to monitor the activity of several users. The administrator device 60 may be granted permission to access the profiles and information relating to one or more users by, for example, a user device 20 transmitting a request to the server 50 that an administrator device 60 be granted access to the user's profile and information, forwarding the request by the server 50 to the administrator device 60, and sending an acceptance of the request back from the administrator device 60 to the server 50.

The present invention also provides an artificial intelligence (AI) data analytics and coaching component. The system provides guidance to the user based on their baseline level of health and fitness, as determined by a baseline assessment as described herein, and their selected goal for health improvement. Through data collected continuously and passively from the user's wearable device and data submitted by the user through the user interface, the platform creates an ever-deepening profile of the user's health and progress. The input data are analyzed, together with data from other users on the platform, to provide unique recommendations to the user that steer the user onto the optimal path to reach their goal. The platform continues to grow in accuracy as the amount of data collected per user and the number of users grows.

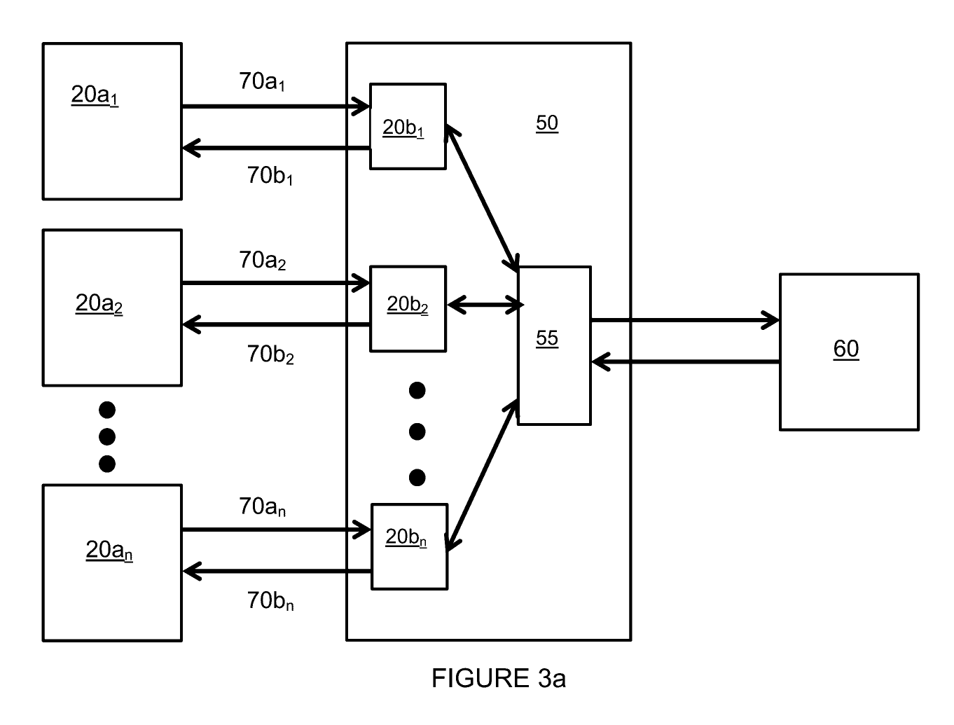

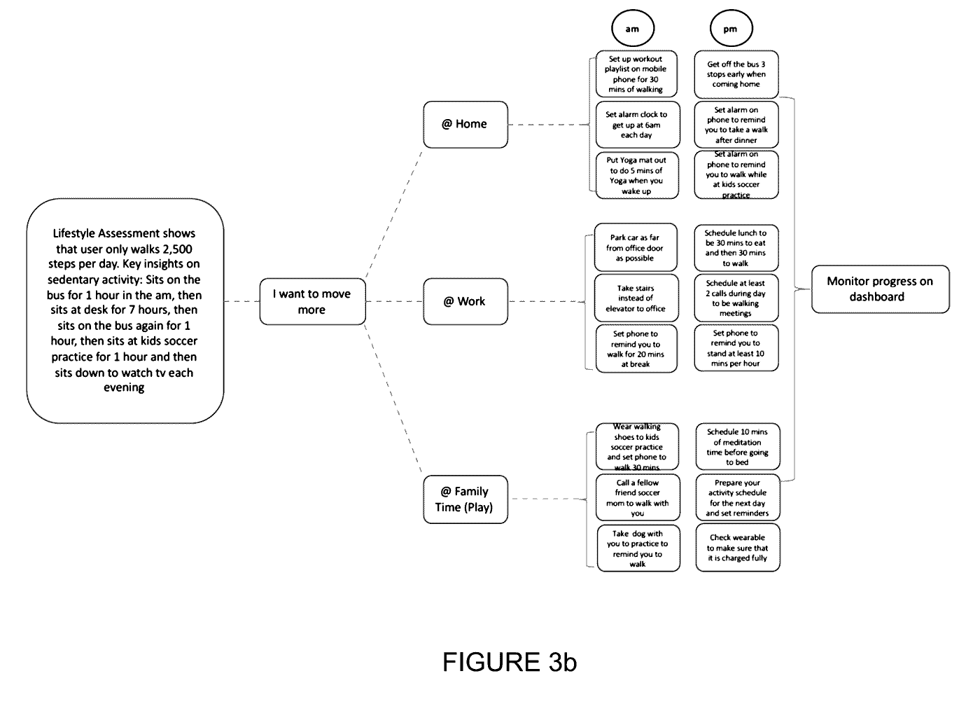

An example embodiment of the system is shown in FIG. 3a. The system includes a number of users (n), each having a user device 20a₁-20aₙ. The user device 20a₁-20aₙ may be a wearable device, such as a smart watch and/or mobile device known in the art, that is configured to track health and fitness information of the user without requiring manual user input for certain health and fitness parameters, such as sleep patterns, steps taken, and pulse. The user device 20a₁-20aₙ may comprise a user application program stored in a memory of the device and executed by the processor of the device that provides the user with a user interface on the display of the user device 20a₁-20aₙ, which allows the user to access and interact with the platform 10 of the invention. The user can provide a manual input of information using the user interface of the user device 20a₁-20aₙ, or using an associated device synced with the user device 20a₁-20aₙ. Each user device user device 20a₁-20aₙ is associated with a particular user, and each user has an associated user profile 20b₁-20bₙ, remotely stored in a server 50. The user device user device 20a₁-20aₙ transmits (70a₁-70aₙ) user data on a number of health and fitness parameters that have been detected by the wearable device and manually input by the user, with a request to provide a recommended routine to the user device 20a₁-20aₙ. The user data may include specific data regarding the user's health and fitness, as well as an indication of a particular aspect of the user's health that the user wishes to improve. The transmitted information is stored in the user profile 20b₁-20bₙ of the server 50.

The server 50 is configured to determine a recommended routine for transmission to the user device 20a₁. The server 50 comprises a recommender engine 55 configured to store a database of routines, each of which has one or more set of associated health parameters and values for the parameters. The recommender engine 55 receives the request from the user device 20a₁ and the user data for the health and fitness parameters. The recommender engine 55 processes the request and determines a routine for recommendation by comparing the received user data on health and fitness parameters with the stored health and fitness parameter information that is associated with one or more routines. By receiving similar input data from other user devices 20a₂-20aₙ, users can be segmented into groups based on providing similar input data. For example, the users associated with user devices 20a₁-20aₙ and user profiles 20b₁-20bₙ, can be grouped into a segment based on having similar age, sleep patterns, physical activity input data, and routines that have been completed successfully by users in a segment to improve an aspect of the user's health, such as improving sleep, an association between the user data and the successful routine can be stored for recommending to another user in the segment. The most approximate match between the user data and the stored data is determined, and the routine associated with the stored data is transmitted (70b₁) to the user device 20a₁, and presented to the user in the user interface of the user application. Further, the recommended routine transmitted to the user may comprise additional instructions for execution by the user device 20a₁. For example, the user device 20a₁ may transmit to the server 50 with the user data, information relating to scheduling information about the user, which can be input by the user manually or determined by the server 50 or user device 20a₁, by, for example, determining the time periods when the user sleeps and determining using geographic positioning in the device 20a₁ the time periods a user is frequently at home, at work, or another location by determining the durations of time and times of day the user device 20a₁ spends at particular locations. The routine transmission 70b₁ may include additional schedule information specific to the user, which can be executed by the user device 20a₁ to instruct the user to perform a routine at a particular time of day or when the user device 20a₁ is at a particular location, considered to be conducive to performing the routine. The user profile information may also be transmitted to the user device and displayed on request from the user device or at a regular frequency.

After the user device 20a₁-20aₙ receives the recommendation, the user can perform the routine and the user device 20a₁-20aₙ will continue to collect data on the health and fitness parameters, which are detected by the wearable device and manually input by the user. This collected data continues to be transmitted to the server 50 and analyzed. If it is determined from the further collected user data that a user is not receiving the intended results of the routine or not achieving the routine, the recommender engine 55 is configured to modify the association between the originally recommended routine and the one or more set of health parameters and values for the parameters, in order to reflect the ineffectiveness of the previous recommendation and to improve the accuracy of the association for future users. Thus, as the number of users (n) increases, the accuracy of the recommender engine 55 increases. An administrator device 60 may also communicate with the recommender engine 55 to provide further routines and manually adjust the routine and data associates as necessary.

An example of a habit or routine recommendation system for a particular user is shown in FIG. 3b.

The evolution of the system shown in FIG. 3a can be explained as occurring four stages. In the first stage, data collected by the user's wearable device 20a₁ and other input data such as meals, energy levels, and other personal metrics, are transmitted 70a₁ from the user device 20a₁ to the server 50 storing a user profile 20b₁, and stored in the user profile 20b₁. During an initial assessment period, which can be ten days for example, such data is collected and stored in the user profile 20b₁. An aggregate determination based on the user's health and fitness levels as well as their daily patterns is made based on the assessment period. Recommendations are determined for the user at the recommender engine 55, which have been provided by experts in the field of fitness, nutrition, sleep and wellness, and are transmitted 70b₁ to the user device and displayed on the user device 20a₁. These recommendations will be applied using proven training and behavior protocols to individuals and groups that are similar. During this phase of the development, the user device 20a₁ can be automatically prompted with recommendations and updated daily on progress in meeting the recommendations. In addition to the recommended goals for health improvement, the user device 20a₁ also receives a set of recommended habits to implement. The user is able to utilize the habit scheduler to plan their healthy habits out for the day and is prompted throughout the day to check in as to whether they achieved the habit.

In the second stage, as the number of users grows, the platform 10 is able to cluster users more precisely according to many different metrics. More targeted training and behavioral protocols are created and presented to the users. Because of the growing numbers of users, and the increasing amount of data per user, the platform can create many more groups of users who are similar to each other, within their group. In addition, the users are segmented and the goals and habits that users are targeting are grouped so that the best paths for health improvement can be shared in a predictive manner. In the third stage, the platform 10 supports many more users who are accessing the platform user application on a regular basis. Each user's feedback from the system is unique based on that user's initial assessment, daily performance and specific future health improvement goals. The system updates the guidance provided to the user from the previous day's data so that each user stays on course towards their own personal goal. In the final stage, the platform 10 will support data analytics at a population or group level to provide insights on key data points including activation, ongoing engagement, key health pillars, health habit formation success and goal achievement. This ability to look at data in a more detailed manner while still keeping it aggregate and non-specific to a user, will provide the ability to analyze how well wellness programs are working which can provide key insights on population needs, incentive benefit plan design and overall program communication and management.

An additional key element in the system provides for the user to be connected to a coach throughout the process if they choose. This support element allows the coach and user to check-in on a regular basis. This accountability check in provides a great opportunity for the coach to review the data for the user and provide key insights to the user on tips and recommendations for achieving their goals while also providing motivational feedback on what they are doing well on. Health coaches can interact with one or many members through the platform thus allowing a better overall experience for their member services. Health coaches like the idea of members using technology (e.g., wearable devices and applications), but desire an easier way to view the data and to provide feedback to members. The system of the present invention will give the ability to view one member or many at one time and also provide them with a unique system for helping the users to improve their health. Coaches can also run challenges with groups and teams.

The following outlines various additional features of the innovative platform and system of the present invention.

A baseline lifestyle and metabolic assessment is provided in accordance with the present invention. The health baseline assessment challenge provides the user with an objective look at where they are currently on the health spectrum, supplying them with a true starting point for change. The user will participate in a 7-10 day assessment of their current lifestyle and daily living patterns. Once the assessment is complete, the user will receive feedback on their particular area of interest for health improvement. This is also an opportunity to educate users about the interrelationships between the pillars that they may not understand. For example: if the user is interested to get more active, then the system will share with them what their current state of physical activity is on a daily basis and realistically what a growth goal could be. The user can choose whether to accept the goal as their starting point or to set a higher goal. This is also an opportunity to educate the user on the interrelation between the health pillars. This realization will help the user to be realistic in setting their goals to get started. The user will then select the habit/goal to be achieved and the system will guide them through from this point on. An overview of an assessment is as follows:

First, the user's personal wellness history and present realities will be unveiled, which are clues to the user's overall health and wellness. This will include looking back and understanding when the user was most happy with his or her state of health and wellness. It will also include having them rate the user's wellness. The user will be given different choices to consider for rating themselves. Psychological and sociological demographic data is used to help them rate themselves. The individual will also describe their surrounding world. Wellness is not just about how a user moves or what they eat. The user's surroundings affect what they are able to achieve. People and surroundings can enhance a wellbeing journey or inhibit it. The present invention will help the user to understand this aspect of wellness.

Second, an objective analysis of current daily lifestyle patterns is provided. During this step, the user participates in a seven day lifestyle and metabolic assessment. The user will wear the wearable and/or digital health device for a period of time, during which data is collected from the user from the wearable device relating to a number of health and fitness parameters, such as user activity and sleep information, and input by the user. This period may be for approximately seven days to provide a clear and objective review what the user is actually doing on a daily basis versus what the user perceives he or she is doing. Users receive a detailed insights report that will detail for them their actual daily lifestyle results, including daily physical activity, daily exercise intensity, daily sleep patterns, and daily nutrition patterns. The report will include special notes on key areas that provide opportunity for improvement along with evidence based feedback on how to properly set goals for improving. In certain embodiments, the user will also receive these insights report on a weekly basis going forward to show them how they are progressing from their original baseline. Each insight report may provide, for example detailed information to identify where the user is achieving above or below recommended goals for a particular health pillar. For example, as the physical activity and exercise intensity areas is examined, a detailed graph of daily activity and exercise intensity hour by hour is provided with associated flags for when the user had the greatest level of intensity. In addition, timeframes when the levels were at their lowest can be noted. Below the graphs, information is provided to the user on proper levels for individuals to achieve on a daily basis. The baseline assessment can be determined by the server 50, for example, by receiving input and detected data from the wearable user device over a predetermined period of time, such as seven days, comparing the received user data with data received from other users to determine where the user may be below or above expected for a health or fitness parameter, generating the assessment report and transmitting the assessment report to the user device for display to the user.

Third, the system may have the user describe himself or herself in the world of well-being that they want to be. The user will write a wellness vision as well and describe what health and wellbeing means to them. The user will describe what an active lifestyle looks like and what a healthy diet looks like and what getting enough rest daily looks like. The user will also describe what healthy habits look like.

Once the user knows where he or she wants to go, the system will guide the user for how to get there. This is the launching point of the healthy habit and behavior change wellness platform. The system focuses on the establishment of sustainable healthy habits. These habits, once established will help the individual increase the intensity of their activity and overall health goals.

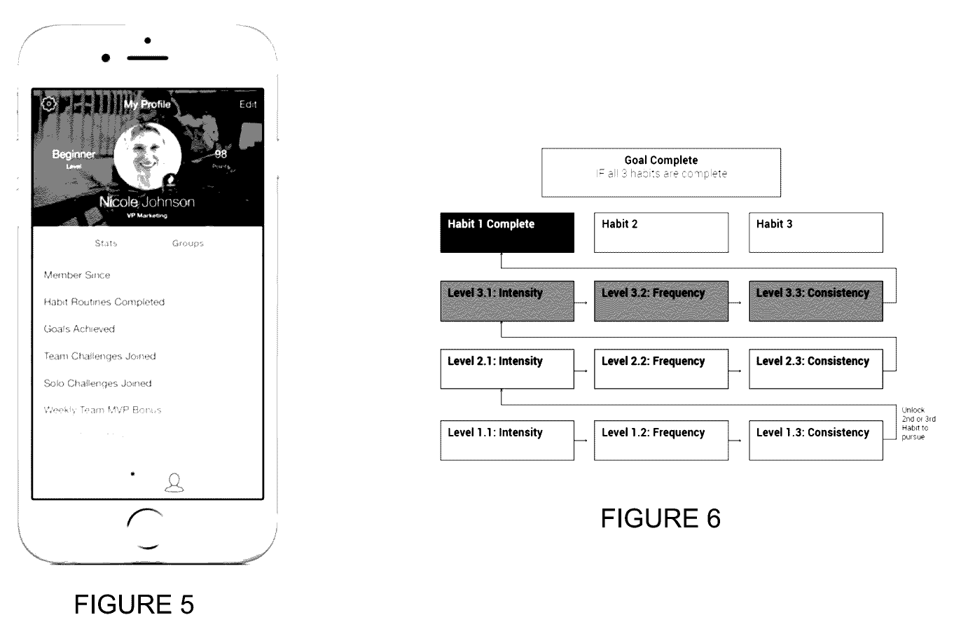

An example of a user profile within the application of the invention is shown in FIG. 5.

The present invention also comprises an intelligent behavior change system. Users will be guided to set reasonable targets towards their long-term health improvement goals. Most of the goals being set today by users are arbitrary and do not apply to a baseline starting point. Users will also have the ability to select multiple health goals at one time to improve on as well, such as sleep better, get more active, eat healthier and increase exercise intensity. Once the user has set his or her goals, the user will be guided on health improvement in accordance with the system described previously herein. The first step is to plan out the user's first day, whereby the user will be prompted to plan their health habits for the day using the habit tip recommendations (from the habit library) and using the habit scheduler to plan out their habits in their daily calendar/schedule.

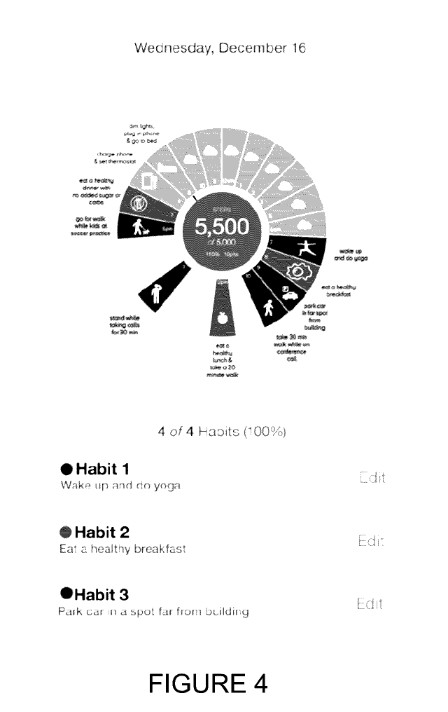

FIG. 4 shows a diagram of a habit scheduler or habit calendar. The habit scheduler will allow a user to select one to three habits that they will execute daily. The present invention uses a method for habit formation that includes reminder (the trigger that initiates the behavior), routine (the behavior itself) and reward (the benefit gained from doing the behavior). In the system of the present invention, the “reminder” will be the Habit Scheduler, which may allow the user to schedule the times at which the habits will take place, or the system may determine appropriate times for the user device to remind the user based on an analysis of the user's movement over a period of time to determine when in the course of a day a user should perform the habit. A user can schedule the habit routine in the user application at the specified timeframe for the action to take place. The “routine” will be the actual healthy habit that is selected out of a healthy habit library. The library consists of habits for each key health pillar. The “reward” may be a set of prompts that the user has preselected as their motivational messages, such as music, congratulatory messages or inspirational messages. The user can preset these reward prompts in the user application set up process.

The habit library is compiled by health experts and provides examples of health habits to help the user. Examples of habits provided to the user for improving physical activity may include setting workout clothes out at night for morning, setting an early alarm early, scheduling time at lunch for a 20 minute walk, writing activity habit on chalkboard in kitchen, or getting off a bus two stops early from work. Examples of habits provided to the user for improving sleep may include getting new cooling bedding, turning the thermostat down at night, dimming lights two hours before bedtime, charging phones outside of the bedroom, or turning off the TV one hour before bedtime.

Goals can be considered the sum of three or more habits. Each goal has a core focus that relates to one of the five health pillars. However, the supporting habits can be drawn from across the various health pillars. For example, a goal “I want to feel more rested” might include not only a sleep habit but also an activity and exercise habit, since it has been shown that individuals with greater activity each day sleep better.

Habits, as defined by the present invention, possess certain attributes: a target—the ultimate measurable habit to create and sustain, a reminder—a conscious cue defined by the user based on time or location, a routine—a sequentially connected series of routines that incrementally build in intensity, and a reward—points that build up the participant skill level and that can be celebrated socially for emotional resonance. Initially, an individual may only pursue one habit at a time, but as the user completes routines, up to three habits within that goal can be pursued. Quantitative progress can be measured through objective means (wearable and digital health devices) and qualitative progress through subjective means (daily interaction with the application).

An example of the relationship between Goals and Habits is shown below in Table 1. With the system of the invention, in order to aid a user in meeting targets, the user's wearable device or mobile device can be configured to initiate and send a reminder to the user at a pre-determined time or when the device determines that the user is at a pre-determined physical location, as determined by the geographic positioning system of the device.

TABLE 1

| Goal | | | | |
|---|---|---|---|---|
| Long- | | | | |
| term | Focus | Habits | | |
| goal | Area | Activity | Exercise | Sleep |
| I want | Sleep | Target: Consistently get | Target: 30 mins. of | Target: Get 7+hrs |
| to feel | | 10,000 steps per day | exercise activity per | of sleep each night |
| more | | | day | Target: Maintain a |
| rested | | | | consistent sleep |
| | | | | and wake time |
| | | Routine: (example) | Routine: (example) | Routine: (example) |
| | | Get at least 1 day with at | 1 week with at least | 3 weeks with at |
| | | least 5,000 steps | 5 days of 5 mins. of | least 5 days of 6 hrs. |
| | | | exercise | of sleep |
| | | Reminder: When | Reminder: At wake | Reminder: Go to |
| | | entering the office (GPS) | (6 a) and at lunch | bed at 10:45 p |
| | | and after dinner (7 p) | (11:45 a) | |
| | | Reward: Points + | Reward: Points + | Reward: Points + |
| | | announcement in feed | announcement in | announcement in |
| | | | feed | feed |

The habit building process of the present invention uses a structure that allows the system to encourage incremental growth towards the target. The following principles drive the structure: (1) establish the habit first in terms of intensity and daily frequency, and (2) then motivate users to sustain the habit while increasing the intensity over time to reach the target intensity overall.

The “healthy habit-tree” structure is measured by three dynamics that follow each other sequentially: (1) Intensity: a quantitative amount measured objectively, such as steps, exercise intensity, or sleep efficiency; (2) Frequency: the number of days in a seven-day week period that user achieves the desired routine; and (3) Consistency: the number of consecutive weeks that the user can sustain the habit routine.

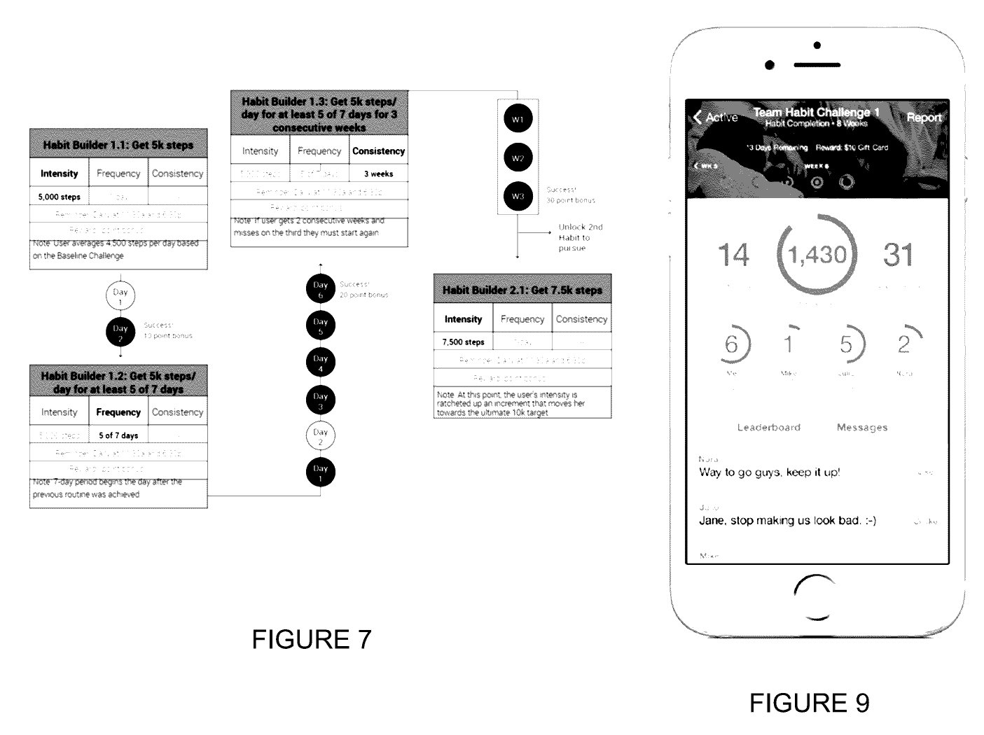

An example of the habit-building process is shown in FIG. 6. Pursuing and achieving habit routines will take varying amounts of time to complete. In this scenario, the user is able to complete all Level 1 habit builders in just over six weeks. The user is then moved up to Level 2. At the same time, the user unlocks the ability to pursue a second habit. Initial habit intensity level targets are based on a percentage increase of the daily average established by the baseline challenge. Later on, the target will be based on the user's daily average for that metric informed by the use of the wearable and/or digital health device. This reduces the likelihood of the user gaming the system by manually setting the targets too low. An example of pursuing a habit is shown in FIG. 7.

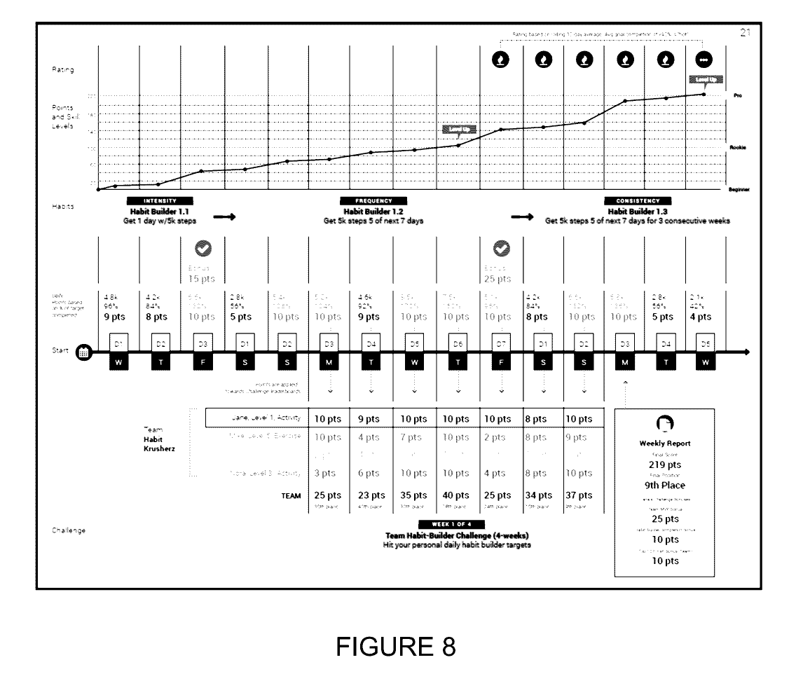

Healthy habit challenges provide individuals and teams the ability to participate in a challenge that is based on healthy habit formation and on a particular health pillar that is important to them. The challenges provide the ability for users of all different health and fitness status together to participate in healthy habit formation while being on a level playing field. An example of a health habit challenge is shown in FIG. 8 and a screen shot for a healthy habit challenge in the user application of the invention is shown in FIG. 9. In accordance with the invention, the system will have the ability to pick out specific habits to improve throughout the user's journey and throughout the challenges. The areas will cover key health pillars such as exercise. A challenge may include, for example, doing a number of pushups each day for a month, incrementally increasing the number each day in order to build strength in a consistent manner. The user will receive points for each day for achievement in the challenge of the overall habit. This way, throughout the challenges, different pillars of health are emphasized and kept fresh for the participants. Some other examples might be to get seven hours of sleep each night, to drink eight cups of water, and to get thirty minutes of moderate exercise. These thirty-day challenges will be incremental to the users overall participation in the wellness program.

A healthy habit points system of the invention combines the unique methodology of habit formation and the data from wearable devices and applications into one simple number for the user. Points are generated daily based on the percentage of the daily habit target that the user achieves. In addition, users can acquire additional bonuses by completing habit routines and/or participating in challenges. Points are based on the percentages of completion of a daily habit target or a daily challenge goal. Points denote the user's overall achievement using the system and cannot be taken away. The points become part of the user's profile and can be viewed by other users as a way of gauging the user's skill level. An example point system may include 10 points for 100%+, 9 points for 90-99%, 8 points for 80-89%, 7 points for 70-79%, 6 points for 60-69%, 5 points for 50-59%, 4 points for 40-49%, 3 points for 30-39%, 2 points for 20-29%, 1 point for 10-19% and 0 points for 0-9%.

Users will move through various skill levels based on their cumulative points. The intent is to provide a scale for users to measure their progress. It also provides a logical basis for matching individuals into teams. Skill level should be seen as a badge of honor—a reflection of building healthy habits, achieving goals and performance in challenges. An example point and skill level system may be for example: 0-100 points for the “Beginner” skill level, 101-300 points for the “Rookie” skill level, 301-1,000 Points for the “Pro” skill level, 1,001-2,000 for the “All-Star” skill level and 2,000 or more points for the “Legend” skill level.

Independent from an individual's points, which represent the user's total experience and achievement, is the user's rating—an indexed rating reflecting a user's recent performance over the last 10 days or other predetermined period of time. The rating is based on a rolling 10-day average, so it can change from day to day. The user rating is a simple tag that denotes that the individual is consistently hitting their daily habit targets and contributing to their teams. An example user rating scheme may comprise a “Hot” rating for a daily average greater than 90%, a “Cold” rating for a daily average less than 50%, and a “Normal” rating for a daily average in between. The rating can appear as a simple tag associated with representations of the user in various aspects of the interface, such as: user profile, home screen with feed, user posts to message feeds, challenge leaderboards and team breakdowns of individual point contributions.

The scoring logic includes a range of desired actions that drive the rating, including daily points production (higher scores reflect greater success), recent habit routines completed (bonus points), challenge progress (point production), challenge performance (weekly bonus points).

For example, Nicole has been using the system for four weeks. In the past ten days she has: generated 75 points out of a possible 100 (75%) for daily targets, completed one habit routine worth 20 points, achieved 65 challenge points out of a possible 100 (45%), received an additional 25 bonus points for performance in a challenge. Nicole's total points are 185 (92.5% of the total) and here user rating is “HOT”, which is indicated to the user by an icon appearing next to her name in the user application.

Challenges are a way to increase engagement and motivate users to sustain their activity over longer periods of time. Challenges have several attributes to be defined, including the challenge name, participant groups, duration of time, measurement being tracked, the type of challenge, the challenge reward and bonuses. The challenge may be provided with a name, such as something fun with a fixed character limit that distinguishes the event. The challenge may also identify groups whose members will be invited to participate (e.g., Employer Wellness: workgroups such as accounting, marketing, sales, operations, etc. Fitness Clubs/Health Coaches: members of said clubs or trainer/health coach). The duration of time is the point in time where scoring participant activity begins (e.g., Midnight on a given day). The challenge measurement is the specific measurement being objectively tracked by a wearable or digital health device: (e.g., steps, exercise intensity, exercise duration, etc.). In certain embodiments, up to two measurements can be selected per challenge. In a multi-measurement challenge, participants will be scored based on their ability to achieve both targets (e.g., 8,000 steps and seven hours of sleep). The challenge type can be in certain embodiments: solo, team, standalone or habit. In a solo challenge, the individual competes against all other individuals in a group. In a team challenge, the individual is automatically assigned to a balanced team of individuals based on their individual skill levels. A standalone challenge is a challenge where each participant user is trying to reach a common daily target for one or two metrics. Points awarded daily are in addition to daily habit completion points. A habit challenge is based on participants' ability to achieve their personal daily habit targets. This allows individuals of different skill levels to compete on a level playing field with a common scoring mechanic based on percentage of daily target achieved. There are no additional points awarded daily outside of bonuses. The reward is optional for a challenge, and may include a reward with a cash value that is awarded to the winner(s) at the end of the challenge (e.g., a gift card, a sponsored gift, an organizational perk, etc.). Bonus awards can also be assigned from a predefined library of options (e.g., 3-day streak, Team MVP, Top 10 Finish). Points can be awarded weekly for the duration of the event.

An example of the integrated points logic for habits and challenges is shown in FIG. 8 and described as follows. Nicole is new to the system, so her skill level is “Beginner.” She has selected “Feel More Rested” as her goal and has selected “Be More Active” as the initial habit that she would like to create. This habit focuses on increasing her daily steps. Her initial Habit Routine intensity target is to get to 5,000 steps in one day—about a 10% increase over her daily average (assessed during the Baseline Challenge). She begins on Wednesday. With each day Nicole receives points based on the percentage of her goal that she has achieved. She completes Habit Routine 1.1 (one day with 5,000 steps) on her third day (Friday). The next day she begins Habit Routine 1.2 which focuses on frequency (Target: 5 of next seven days at a 5,000 steps per day intensity). At the same time Nicole receives an invitation to participate in a four-week team habit routine challenge. She is automatically assigned to a balanced team of four individuals based on their skill levels. There are 50 teams in the challenge. As each team member pursues completion of their personal habit routines, their personal daily points are applied to their team.

At the end of the week, the team member receives bonus points based on their individual performance as well as their teams. The bonuses from completing Habit Routines and participating in challenges help Nicole to increase her skill level. On her ninth day, she levels up to “Rookie.” On her tenth day, Nicole's user rating of “Hot” appears an indicator of how well she is producing points based on her habit completion and challenge performance.

Participants can participate in standalone challenges independent from their habit builder targets. This will yield additional points but will be scored using the same mechanics. An example is shown in FIG. 22.

Healthy behaviors content provides users with health content in a video format tied to their healthy habit selection for improvement. This synchronized content will help provide tips to users on what is important to them.

A healthy habit data analytics dashboard provides administrators of wellness and fitness programs the ability to see a dashboard of participants and how well they are doing in the program in developing healthy habits. Administrators will have the ability to review: the number of participants, demographics of participants (e.g., gender, groups, offices/clubs and teams, detailed population data on key measures in physical activity (steps, distance, calories burned), exercise (vigorous, moderate and sedentary intensity levels), sleep (sleep efficiency, time asleep, time awake), team leaderboards with team points/scores and key habit builder goal achievement performance.

A wellness platform coaching application provides administrators and health coaches the ability to access their members' progress individually or as a group remotely to provide inspirational and educational messages of motivation and to track the progress of their success. This coaching platform will also be able to utilize the health challenge capabilities to enable them to deploy these healthy habit challenges with small groups of members or across a fitness and health chain.

In accordance with the present invention, a user application is provided, which can be stored in the memory of a user device, including a wearable device, mobile device, ear devices, eyeglasses, apparel-based monitoring product (such as, shirt, pants, shoes, socks, underwear, etc.) and any associated device, and executed by the processor of the device, for allowing the user to interact with the system of the invention, including communicating with the server and any other user or administrative devices. The user application, through a user interface and display screen of a device, allows the user to navigate between a home screen where the user can access progress towards goals and monitor daily activity, challenges, and a user profile where the user can display their statistics, vitals and related group information. Various screenshots of the user application are shown in FIGS. 9-21.

FIG. 9 shows a screen display in the application relating to a summary of a challenge in accordance with an embodiment of the invention.

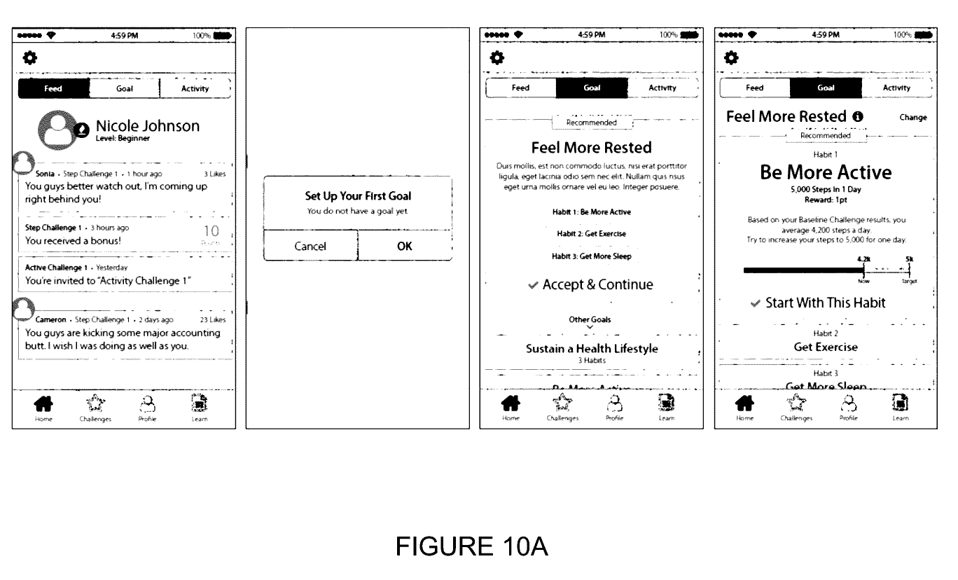

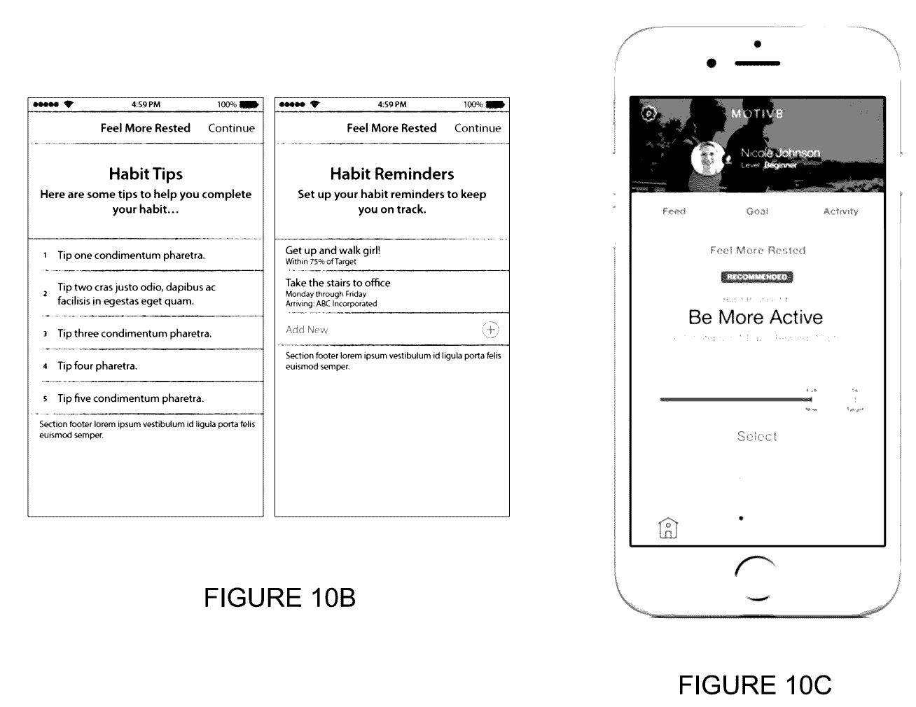

FIGS. 10A-10C show a series of screen displays relating to the selection of a habit by the user in the application. A home screen is provided for the user, which displays the most recent item at the top of the user's feed. The user is prompted to set up their first goal. One goal, such as feeling more rested, can be recommended to the user based on the results of the user's baseline assessment or a later assessment, as described previously herein. However, the user can override the recommendation and select a different goal. In FIG. 10A, one of the habits, such as being more active, is recommended, but the user can begin with other habits. The other habits are unlocked for selection after the user completes the initial habit routines for a particular habit. The user can select a different habit to display the details for that habit. Habit tips are also presented to the user, which can be accessed by transmitting the content to the user device and updated accordingly. The user may also be presented with habit reminders. An example of a progress-oriented personal target that the user created is shown. The reminder is sent to the user when the user reaches 75% of the target for that habit builder. A location-based reminder can also be provided. The user device comprising a geographic positioning element, can provide a reminder to the user upon reaching a particular geographic location, such as the user's office.

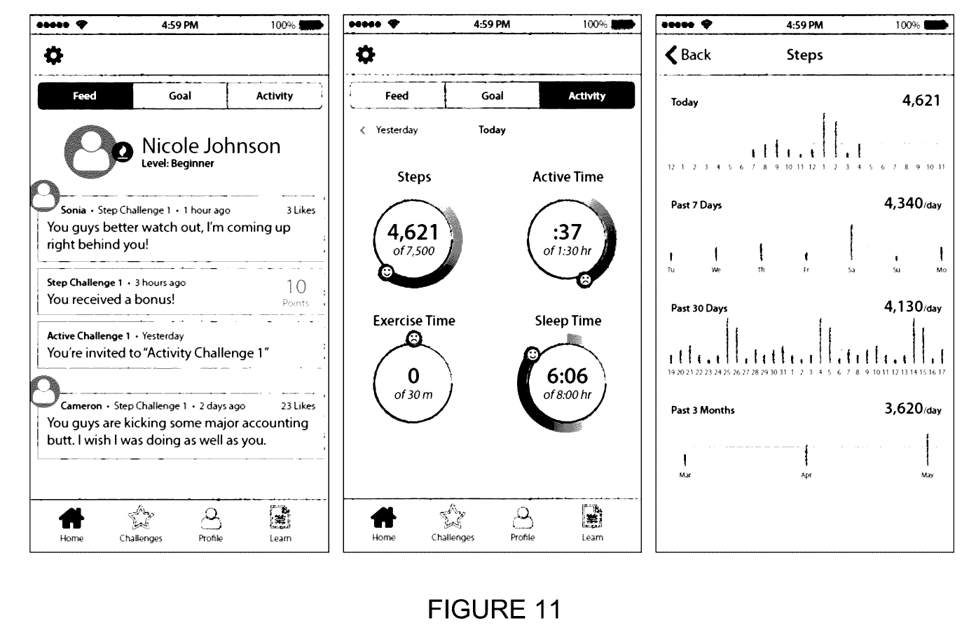

FIG. 11 shows a series of screens of the user application that show a review of daily device data. An activity dashboard displays the current measurements for a user. Icons, such as faces, can be presented, to reflect the user's progress within a 24-hour period. An activity details screen may show a detailed view for any given metric, such as the number of steps taken, and may include a number of different views of data based on time period or behavioral analysis, such as highlighting periods where a user is more or less active.

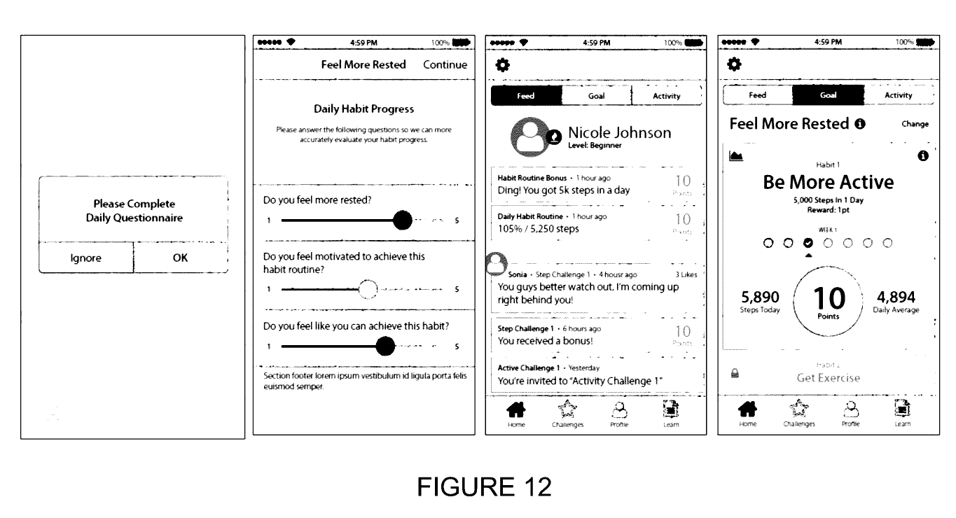

FIG. 12 shows developing and unlocking habits and completing a habit routine in the user application. For users pursuing a goal or habit, they may be prompted to answer a daily questionnaire. It is not mandatory but helps drive a sense of the qualitative changes happening alongside their quantified activity. The questionnaire is short and asks questions that can be rated on a numerical scale. This allows the responses to be tracked and mapped against the user's activity. When the user has activated a habit routine target, the system will automatically allow the user to the next level habit routine. However, this item will be noted in the user's feed and the reward displayed. The user has been automatically advanced to the next habit routine in the sequence. In this case, the user has advanced from Level 1.1 to Level 1.2 (frequency). If a second habit has been unlocked, the user can select which of the remaining habits to start. Once the user makes the selection, the remaining third habit will be locked again until the user completes the first level habit routine for their second habit.

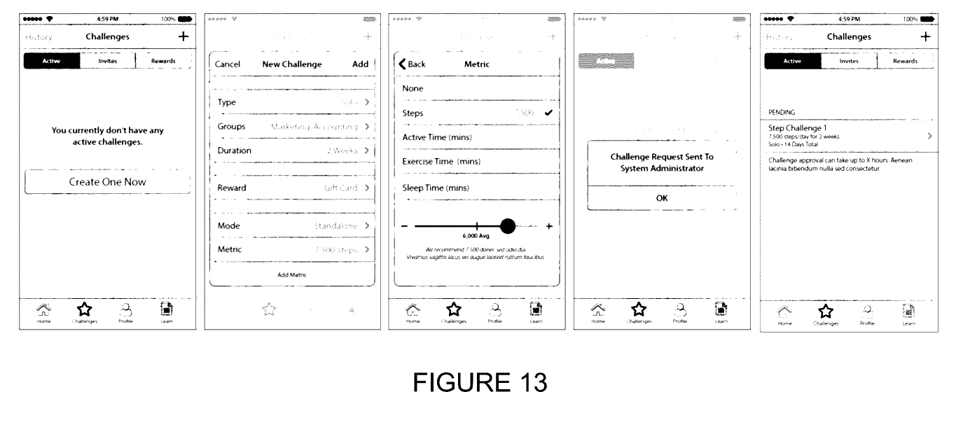

The administrator challenge creator in the user application is shown in FIG. 13. A “History” screen shows a record of past challenges participated in. If the user has not participated in any challenges to date, this button may be grayed out. A new challenge can be created by the user, providing various options for the challenge parameters. A challenge can be solo or team. The user can select multiple groups to participate in the challenge. The user can submit a request for a reward from a list of available options. The user can select up to two metrics for the challenge and set specific parameters for each. Details can be set in a separate modal screen. When user selects a metric, a recommendation appears at the bottom of the form. The user can adjust as needed. The recommendation is based on the average of the groups that the user has indicated to participate in the challenge, but the administrator can override the recommendation. The new challenge request is sent to the administrator and is placed in a queue of requested challenges. The administrator can create challenges, or select from the queue. Submitted challenges may or may not be selected by the administrator. If selected, the user will receive a notification and will automatically be invited to the challenge.

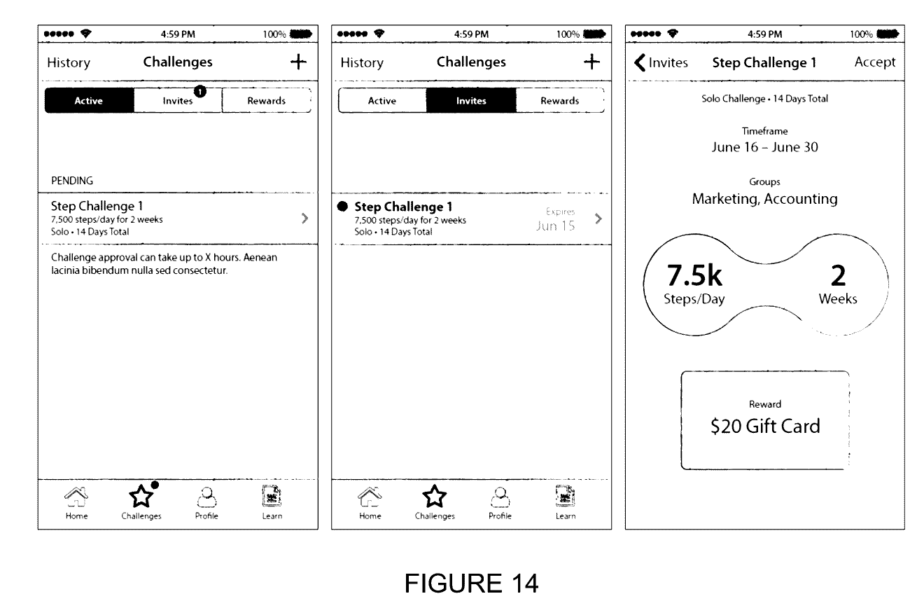

Viewing and accepting a challenge invitation in the user application is shown in FIG. 14. In an active challenges list, a “Pending” list reminds the user of upcoming challenges that the user has accepted and is scheduled to participate in. An “Invites” list shows the user challenges the user is invited to. New invitations can be indicated with an icon, such as a dot, and be presented in a bolded or different style of font. Challenge details are presented. Daily goal and challenge duration can be presented in bold or another font style. If the event has a reward, it is prominently displayed along with potential messaging from partner sponsors.

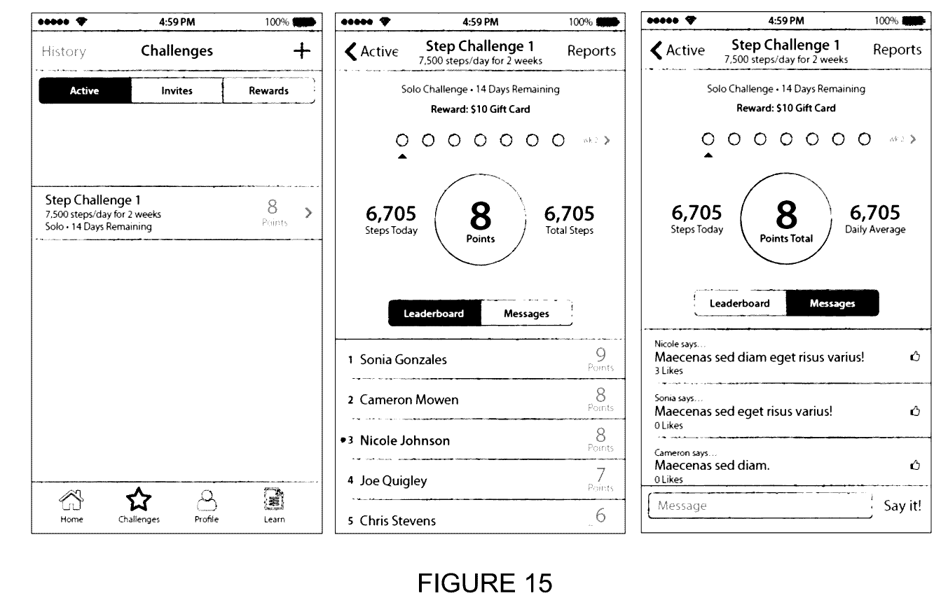

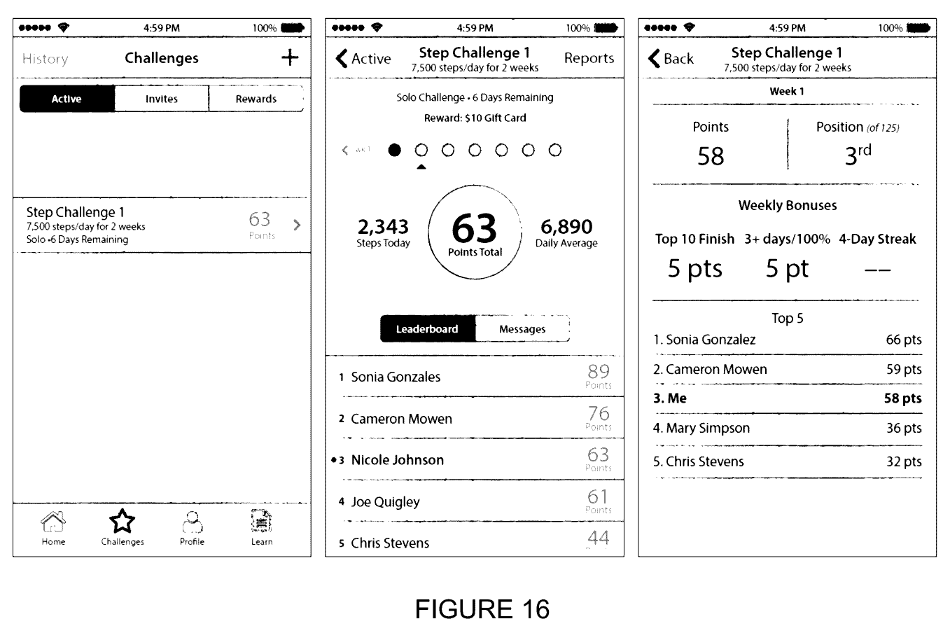

Checking an active solo challenge status in the user application is shown in FIG. 15. Active challenges are displayed in a list and can be ordered by days remaining in the challenge. A summary of challenge details is displayed in a list including challenge name, challenge goal, days remaining, and user's current point total for this challenge. A challenge dashboard shows leaderboard information and message information. Seven daily completion graphs may be displayed for each metric in the challenge to convey a visual history of progress. Week-by-week cumulative status is displayed, including a daily performance indicator, total points, daily metric scores and cumulative scores. The leaderboard displays the user's position in relation to the overall group. In the message portion of the dashboard, messages are displayed in a feed, the user can compose messages to add to a thread, or reply to messages from other users. Viewing a weekly report for a solo or team challenge in the user application is shown in FIG. 16. An active challenges list displays the user's current score in active challenges to date. A “Reports” button appears when a week has been completed. As subsequent weeks pass, the summary for the most recently completed week may be displayed on top, such that the user can scroll down to follow events from week-to-week as they unfold.

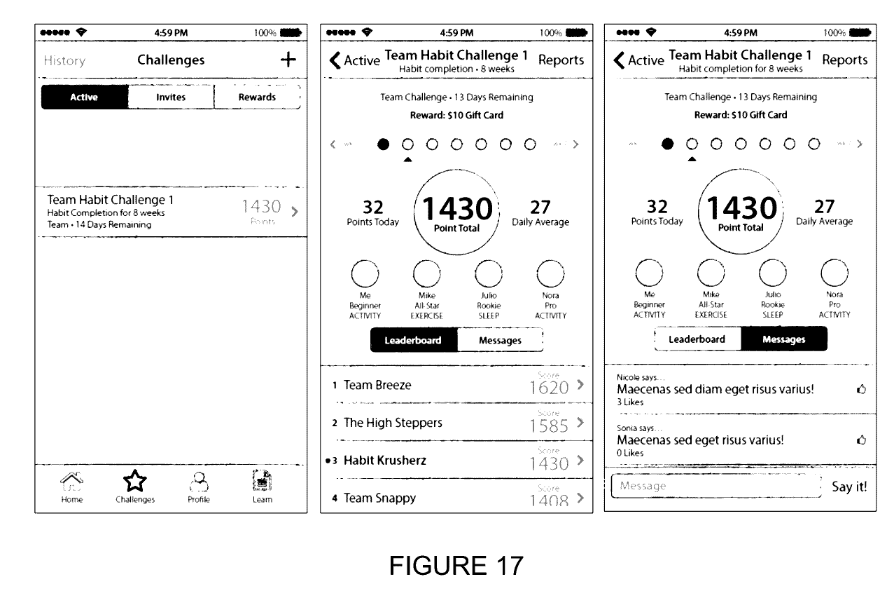

Checking an active team challenge status in the user application is shown in FIG. 17. Active challenges are displayed in a list, and may be ordered by days remaining in the challenge. A summary of challenge details is displayed in a list including challenge name, challenge goal, days remaining, and the user's current point total for this challenge. A challenge dashboard shows leaderboard information and message information. Seven daily completion graphs can be displayed for each metric in the challenge to convey a visual history of progress. Week-by-week cumulative status is displayed including a daily performance indicator, total points, daily metric scores and cumulative scores. A breakdown of each team member's current contribution to the current day's score is displayed. The leaderboard displays the user's position in relation to the overall group. In the message portion of the dashboard, messages are displayed in a feed, the user can compose messages to add to a thread, or reply to messages from other users.

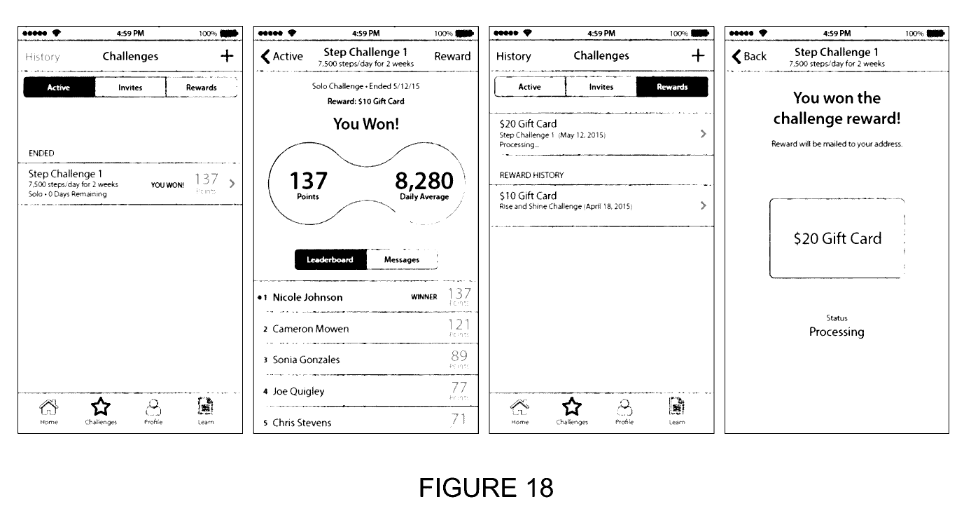

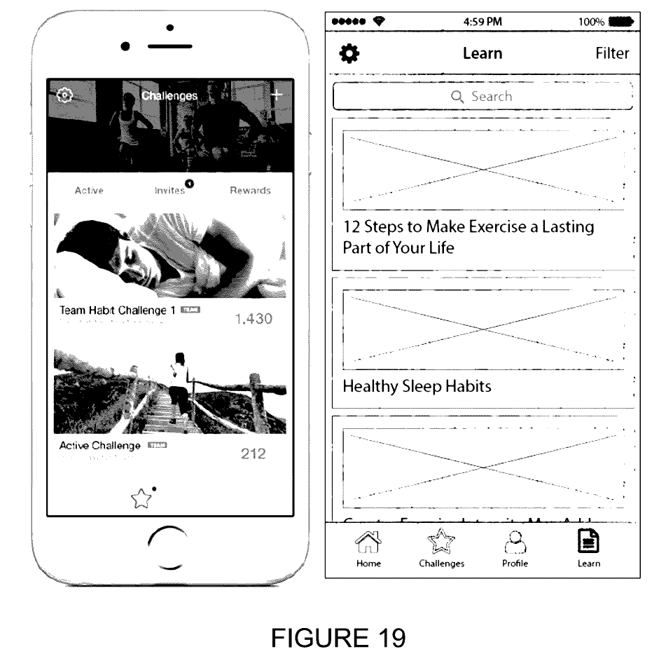

Winning a challenge in the user application is shown in FIG. 18. The final report will display the final results for the challenge, including the complete leaderboard and message thread. The messaging features may be locked after the challenge ends. FIG. 19 shows learning section in the user application. A user can view a personalized list of content based on the user's goal. The content may include stories relating to the individual habits the user is currently pursuing.

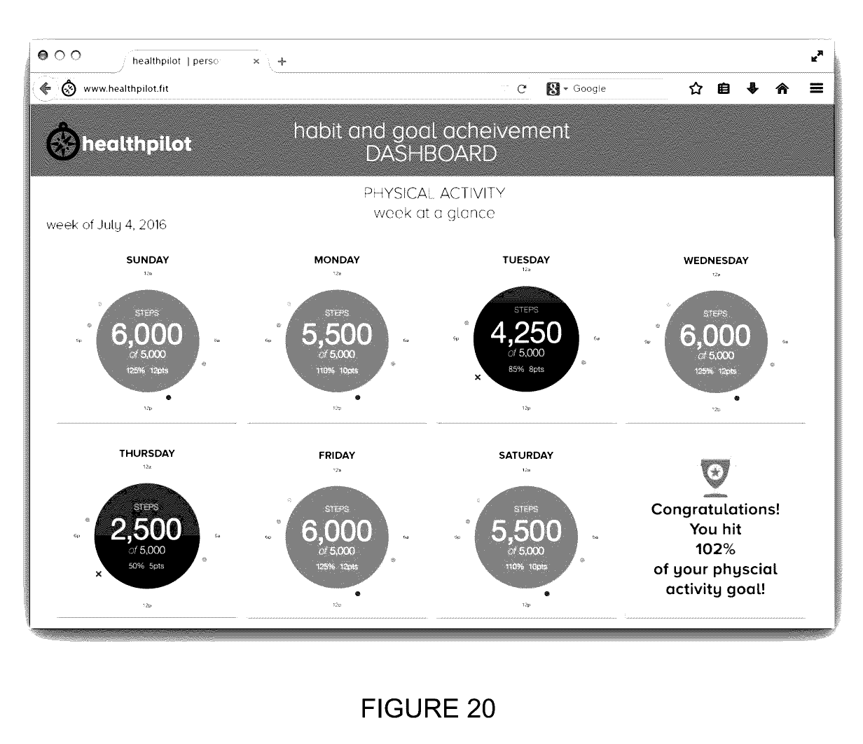

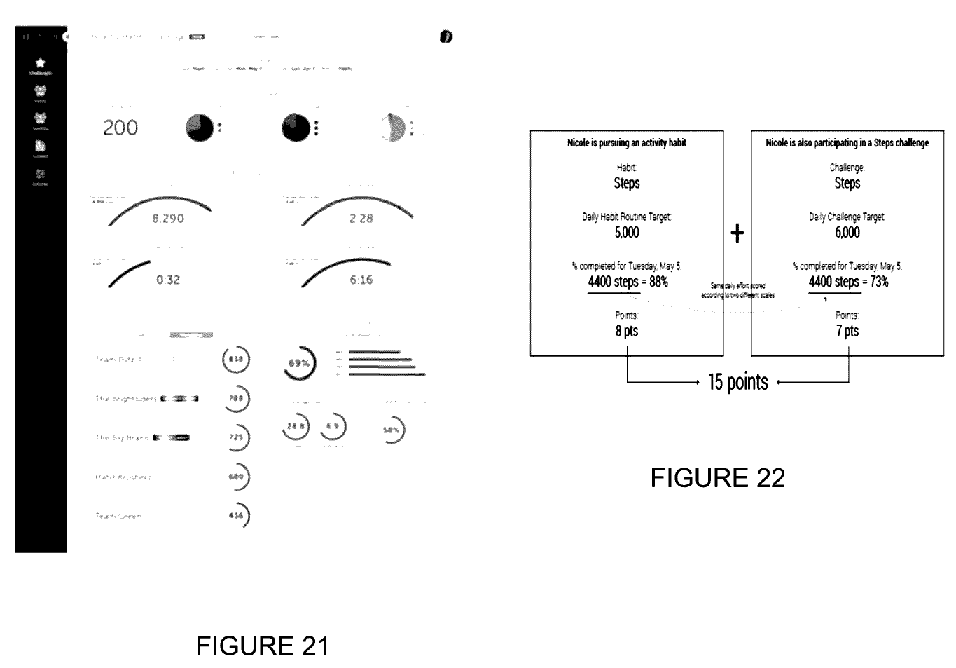

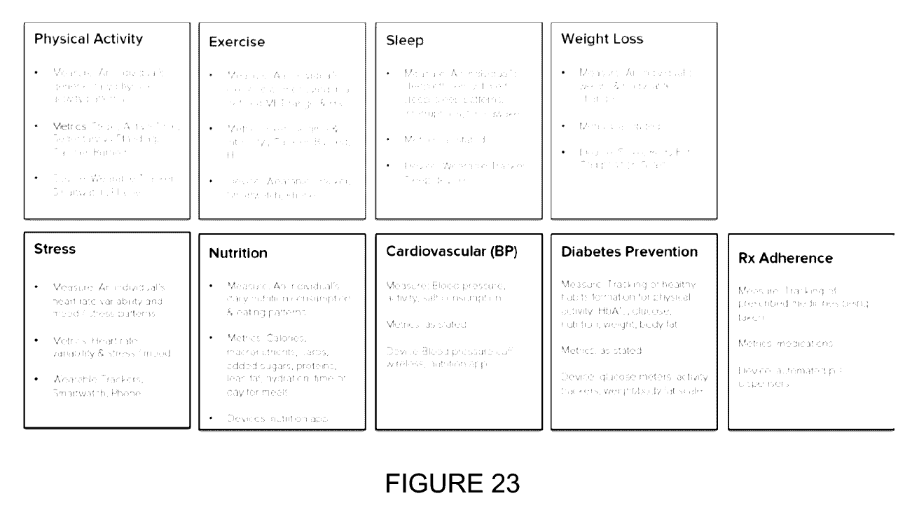

FIG. 20 shows a weekly dashboard for health coaches in the user application. The purpose of this view is to provide a view for the health coach to look in on their member and to provide feedback based on what has happened over a week's period of time, by interacting with the user and providing feedback to the user. This view also provides the ability for the user to look back at their data over the last week to see how they have progressed as well. FIG. 21 shows an administrative dashboard report. The present invention helps guide the user through sustained, healthy habit formation and behavior change in several key areas. FIG. 23 illustrates several of these areas, including physical activity, exercise, sleep, weight loss, stress, nutrition, cardiovascular/blood pressure, diabetes prevention and prescription adherence. Additional areas addressed by the present invention may include but are not limited to: hydration, cardiac rehab, pre-diabetes, diabetes, prescription adherence, drug addiction, heart failure, smoking cessation and orthopedic rehab.

For example, cardiac rehabilitation (“CR”) is a professionally supervised program to help people recover from heart attacks, heart surgery and percutaneous coronary intervention (PCI) procedures such as stenting and angioplasty. The present invention provides a system for patients and medical providers to implement CR programs in a more efficient manner. Currently each year, roughly 915,000 Americans will have a heart attack and more than 30% will have a second and potentially fatal event. It is known that CR reduces the risk of a future cardiac event by stabilizing, slowing or even reversing the progression of cardio-vascular disease (CVD). The problem is that very few patients actually go to cardiac rehab despite its clear benefits. A recent article states that doctors blame it on a number of factors, such as, limited follow-up or facilitation of enrollment after referral, limited or no health coverage, work or home responsibilities, hours of operation of CR center conflicts with work demands, scarcity of programs in rural areas or low-income communities, distance to facility from patient's home, access to public transportation or parking issues and lack of perceived need for rehabilitation.

Stats provided by the American Heart Association show that only 14% to 35% of eligible heart attack survivors and 31% of patients after coronary bypass surgery participate in a CR program. The utilization rate for eligible Medicare beneficiaries is an even lower 12%. The wide treatment gap between benefits obtained from CR and participation is unacceptable. A study by the American Heart Association found that for every short-term disability claim filed due to acute coronary syndrome, the cost to employers was about $7,943 in lost productivity. Each long-term disability claim cost employers about $52,473.

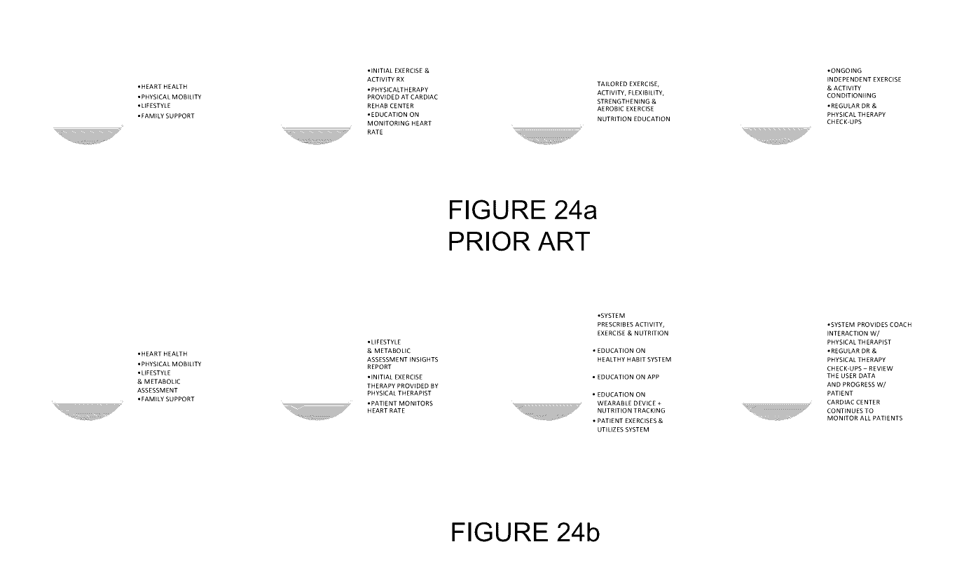

An example of a CR treatment program according to the prior art is shown in FIG. 24a. An example of a CR treatment program implemented in accordance with the system of the present invention is shown in FIG. 24b. Using the system of the present invention described herein provides the medical provider with a means to objectively monitor and assess the patient, using the user application in combination with a wearable device, in their free living environment so that they get an accurate picture of their lifestyle, including nutrition, activity, exercise and sleep, for example. The user is able them to follow a rehabilitation program remotely from the cardiac rehab center, and does not need to regularly travel to a center for completing rehabilitation. The physical activity is recognized for its potential in combating further progression of cardiovascular health degradation, however, in accordance with the present invention, it can be personalized to the patient, as an accessible and scalable digital medicine. The system of the present invention also allows the user to learn proper healthy nutrition in the comfort of their home while tracking and monitoring their nutrition intake on a daily basis. The patient/user will learn about the ingredients in foods, get special recipes and be able to see what substitute for their current diet. Further, the present invention allows for the patient to be monitored by their medical provider but also to participate socially with other patients and get progress and updates daily on how they are doing. Patients are empowered to self-manage and take personal responsibility for sustained behavior change which will improve individual health outcomes and reduce overall costs and readmission rates.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

What is claimed:

1. A health and fitness improvement system comprising:
a wearable user device comprising a user interface, a memory and a processor, configured to:
detect user data relating to one or more health or fitness parameters;
receive user input data relating to the one or more health or fitness parameters through the user interface; and
transmit the detected user data and user input data to a server with a request for a health or fitness routine; and
the server configured to:
receive the detected user data and user input data with the request for a health or fitness routine;
determine based on the received detected user data and user input data a health or fitness routine for transmission to the user; and
transmit the health or fitness routine to the wearable user device.

2. The system according to claim 1, wherein the server comprises a recommender engine configured to store a plurality of health or fitness routines, each associated with a data set relating to the one or more health or fitness parameters, and wherein the recommender engine is configured to select a routine for transmission to the user by comparing the received detected user data and user input data with the data sets relating to the one or more health or fitness parameters associated with the plurality of stored health or fitness routines.

3. The system according to claim 2, wherein the server is configured to store a user profile associated with the wearable user device.

4. The system according to claim 3, further comprising a plurality of wearable user devices, wherein the server is configured to store user profiles associated with each of the plurality of wearable user devices.

5. The system according to claim 4, where each of the plurality of wearable user devices is configured to request and receive a routine from the server, and is further configured to:
detect user data relating to one or more health or fitness parameters related to the received routine;
receive user input data relating to the one or more health or fitness parameters related to the received routine through the user interface; and
transmit the detected user data and user input data related to the received routine to the server.

6. The system according to claim 5, wherein the recommender engine of the server is configured modify the data sets associated with the plurality of stored routines based on the detected user data and user input data related to the received routine from the plurality of wearable user devices.

7. The system according to claim 1, wherein the detected user data includes data relating to one or more of sleep activity, heart rate, steps taken by the user or measured physical activities of the user.

8. The system according to claim 1, wherein the user input data includes one or more of user dietary information, user health information, user fitness information and a requested area of user health or fitness improvement.

9. The system according to claim 1, wherein the wearable user device is configured to provide alarm notifications to the user relating to the performance of the routine.

10. The system according to claim 9, wherein the alarm notification is configured to be triggered when the wearable user device detects that the wearable user device is at a particular geographic location.

11. The system according to claim 1, wherein the server is configured to determine user schedule information based on the detected user data and user input data, and to transmit the user schedule information with the health or fitness routine to the wearable user device.

12. The system according to claim 11, wherein the user schedule information comprises instructions, which when executed by the processor of the wearable user device, instruct the wearable user device to provide alarm notifications to the user relating to the performance of the routine at one or more particular times.

13. The system according to claim 4, wherein the server is configured to segment users having similar user data or user input data relating to one or more health or fitness parameters stored in their respective user profile into a group.

14. The system according to claim 1, wherein the wearable user device is configured to transmit the detected user data and user input data to the server for a predetermined period of time, and wherein the server is configured, at the end of the predetermined period of time, to generate and transmit to the wearable user device a baseline user assessment.

15. The system according to claim 1, wherein the health or fitness routine transmitted to the wearable user device is designed to incrementally improve an area of the user's health or fitness.

16. The system according to claim 1, wherein the server further comprises a content library comprising content relating to a plurality of health or fitness routines, and is configured to transmit to the wearable device with the health or fitness routine, one or more content items from the content library related to the transmitted health or fitness routine.

17. The system according to claim 4, further comprising an administrator device configured to access a plurality of the user profiles associated with each of the plurality of wearable user devices.

18. The system according to claim 4, wherein the each of the wearable user devices is configured to participate in a challenge with one or more of the plurality of wearable user devices and is configured to:
detect user data relating to one or more health or fitness parameters relating to the challenge;
receive user input data relating to the one or more health or fitness parameters relating to the challenge through the user interface; and
transmit the detected user data and user input data relating to the challenge to the server.
